(19) United States
(12) Patent Application Publication
(10) Pub. No.: US 2003/0050979 A1
(43) Pub. Date: Mar. 13, 2003

(54) Information distributing system

(76) Inventor: Kazunori Takahashi, Ehime (JP)

Correspondence Address: WENDEROTH, LIND & PONACK, L.L.P., 2033 K STREET N. W., SUITE 800, WASHINGTON, DC, 20006-1021, US

(21) Appl. No.: 09/959,387

(22) PCT Filed: Feb. 26, 2001
(86) PCT No.: PCT/JP01/01408

(30) Foreign Application Priority Data
Feb. 25, 2000 (JP) 2000-48841

(51) Int. Cl. G06F 15/16

(52) U.S. Cl. 709/204

(57) ABSTRACT

It is a problem that information and an advertisement can be only seen in the idle state of a terminal equipment, resulting in decrease of advertisement value.

A time at which an advertiser displays an advertisement to a client can be specified to the client that has its primary object to display, and a schedule of advertisement display is adjusted based on a fee for the advertisement display in a server when a competition of plural advertisers displaying advertisements at the same time or the like occurs, whereby an advertisement is displayed at a client side at a time desired by the advertiser, resulting in provision of a highly effective advertisement.

### TECHNICAL FIELD

The present invention relates to a system which constructs a network connected by a wired/wireless system and, more particularly, to an information distribution system which distributes information existing on the network to a terminal.

### BACKGROUND ART

A system and method which distribute information and advertisement are disclosed in Japanese Published Patent Application No. Hei. 9-269923, for example. FIG. 36 is a block diagram of an information and advertisement distribution system in this conventional example. Hereinafter, a description will be given with reference to FIG. 36. A work station 102 allocated apart from a data server 104 has a local memory which stores an information item and an advertisement received from the data server 104 and a profiler which stores profile data indicating a subscriber preference.

An information administrator of each work station sometimes establishes communication with the data server 104 to carry out updating using a subset of the information item and the advertisement stored in the local memory. When satisfying a prescribed idle standard, an information display controller of each work station displays the subset of the information item and the advertisement stored in the local memory on a display. The information display controller excludes an information item which does not coincide with profile data of a subscriber.

Since the work station is assumed to be a terminal as described above, information can be only seen in the idle state. Particularly, energy conservation being exclaimed nowadays, it is often the case that a display device is OFF in the idle state, leaving little time for a screen saver to be operated, whereby there is fewer chance to see distributed information and an advertisement.

The purpose of advertisement is to make as many people as possible recognize the commodities. However, the value of the advertisement is reducing in the above-described state. Speaking as an advertiser, the effect by the system for distributing an advertisement is decreasing.

That is, in the conventional information distribution system, information and advertisement can be only seen in the idle state, resulting in reduction of the advertisement value.

The present invention is made to solve the above-mentioned problem and has for its object to provide an information distribution system which can perform an effective advertisement display.

### DISCLOSURE OF THE INVENTION

To solve the above-described problem, an information distribution system according to the present invention can specify a time at which an advertiser displays an advertisement to a client to the client that has its primary object to display, and adjusts a schedule of advertisement display based on a fee for the advertisement display in a server when a competition of plural advertisers displaying advertisements at the same time or the like occurs.

According to the invention, the client which has its primary object to display being employed, an advertisement is displayed at the client side at a time desired by an advertiser, thereby providing a highly effective advertisement.

As described above, according to the information distribution system of the invention, a content profile in which information such as start time for executing content provided by a content server is described is sent to an information distribution server, the information distribution server performs scheduling of content from the contents of the obtained plural content profiles, a time zone is adjusted based on a fee for content execution when the time zone is overlapped, and a script file in which an execution schedule of a client is described is sent to the client, whereby the content can be executed in the client at a time desired by the content server. When the content is an advertisement, the client can display the advertisement at a time desired by an advertiser, whereby the advertisement is remarkably valuable, resulting in a profound effect.

Further, it is possible to acquire content required by a user easily by a keyword search or the like as well as to perform an accounting processing, resulting in an extremely effective system as an information acquiring means.

According to claim 1 of the present invention, in an information distribution system comprising: a multi-purpose communication network which can transfer data by a wired-system cable or by wireless; a client which is connected to the communication network and has its primary object to display contents in a storage means inside; a content server which is connected to the communication network and provides information to the client; and a distribution server which is connected to the communication network, receives a content profile in which contents of content and a utility fee required with content execution are described from the content server, and transfers a script file which can control the content execution in the client to the client, a client execution time at which corresponding content is executed in the client can be specified in the content profile, and the distribution server adjusts the client execution time based on the utility fee when the client execution time has competition.

Therefore, the client which has its primary object to display being employed, an advertisement is displayed at the client side at a time desired by an advertiser, thereby providing a highly effective advertisement. Further, a schedule of advertisement display is adjusted based on a fee for the advertisement display in a server when a competition of plural advertisers displaying advertisements at the same time or the like occurs, whereby a fair scheduling can be automatically performed based on the display fee.

According to claim 2 of the present invention, in the information distribution system as defined in claim 1, the distribution server includes an accounting means which can execute an accounting processing to a content server or a content provider.

Therefore, the distribution server can execute an accounting processing, in addition to the same effect as that of the information distribution system according to claim 1 achieved.

According to claim 3 of the present invention, in the information distribution system as defined in claim 1, the client comprises: a client communication I/F as an interface to the communication network; a script file storage means for storing the script file from the client communication I/F; a client content storage means for storing content data from the client communication I/F; a content executing means for executing the contents of the client content storage means; and a content execution control means for controlling the content executing means with reference to the contents of the script file storage means, and the distribution server comprises: a server communication I/F as an interface to the communication network; a content profile storage means for holding the content profile from the server communication I/F; and a content scheduler which executes scheduling of content to be distributed to the client with reference to the contents of the content profile storage means.

Therefore, the client which has its primary object to display being employed, an advertisement is displayed at the client side at a time desired by an advertiser, thereby providing a highly effective advertisement. Further, a schedule of advertisement display is adjusted based on a fee for the advertisement display in a server when a competition of plural advertisers displaying advertisements at the same time or the like occurs, whereby a fair scheduling can be automatically performed based on the display fee.

According to claim 4 of the present invention, in the information distribution system as define in claims 1, a description indicating urgency can be given in the content profile, the distribution server confirms the description indicating urgency given in the content profile to transfer a script file indicating urgency to a target client immediately, and the client which received the script file immediately receives and executes target content.

Therefore, information with urgency can be immediately displayed in the client, in addition to the same effect as that of the information distribution system according to claim 1 achieved.

According to claim 5 of the present invention, in the information distribution system as defined in claim 4, the distribution server includes an accounting means which can execute an accounting processing to a content server or a content provider.

Therefore, the distribution server can execute an accounting processing, in addition to the same effect as that of the information distribution system according to claim 4 achieved.

According to claim 6 of the present invention, in the information distribution system as defined in claim 1, a keyword and price information of corresponding content can be described in the content profile, the distribution server holds a search engine which enables a search of the content profile by a keyword sent from the client, and content selection can be performed by communicating the keyword and its search result between the client and the distribution server.

Therefore, a user can easily acquire required content by a keyword search or the like, in addition to the same effect as that of the information distribution system according to claim 1 achieved.

According to claim 7 of the present invention, in the information distribution system as defined in claim 6, the distribution server includes an accounting means which can execute an accounting processing to a content server or a content provider.

Therefore, the distribution server can execute an accounting processing, in addition to the same effect as that of the information distribution system according to claim 6 achieved.

According to claim 8 of the present invention, in an information distribution server comprising: a multi-purpose communication network which can transfer data by a wired-system cable or by wireless; a client which is connected to the communication network and has its primary object to display contents in a storage means inside; a content server which is connected to the communication network and provides information to the client; and a distribution server which is connected to the communication network, is provided with a content scheduler which receives a content profile describing contents of content from the content server and executes scheduling of content to be distributed to the client with reference to the contents of the content profile, and transfers a script file which can control the content execution in the client to the client, a keyword of corresponding content can be described in the content profile, the distribution server holds a search engine which enables a search of the content profile by a keyword sent from the client, and content selection can be performed by communicating the keyword and its search result between the client and the distribution server, and information for identifying target content to be accompanied and a fee to be displayed to the client are described in the content profile, information that accompanies the target content to be accompanied is decided according to the contents of the fee in the content profile in the content scheduler, and the client executes the accompanying information before or after the target content to be accompanied is executed.

Therefore, a user can easily acquire required content by a keyword search or the like and the client which has its primary object to display is employed to display an advertisement related to the content displayed in the client, thereby providing a highly effective advertisement, and further, a schedule of advertisement display is adjusted based on a fee for the advertisement display in a server when a competition of plural advertisers displaying advertisements at the same time or the like occurs, whereby a fair scheduling can be automatically performed based on the display fee.

According to claim 9 of the present invention, in the information distribution system as defined in claim 8, the distribution server includes an accounting means which can execute an accounting processing to a content server or a content provider.

Therefore, the distribution server can execute an accounting processing, in addition to the same effect as that of the information distribution system according to claim 8 achieved.

According to claim 10 of the present invention, in an information distribution system comprising: a multi-purpose communication network which can transfer data by a wired-system cable or by wireless; a client which is connected to the communication network and has its primary object to display contents in a storage means inside; a content server which is connected to the communication network and provides information to the client; and a distribution server which is connected to the communication network, is provided with a content scheduler which receives a content profile describing contents of content from the content server and executes scheduling of content to be distributed to the client with reference to the contents of the content profile, and transfers a script file which can control the content execution in the client to the client, a keyword of corresponding content can be described in the content profile, the distribution server holds a search engine which enables a search of the content profile by a keyword sent from the client, and a content selection can be performed by communicating the keyword and its search result between the client and the distribution server, and the content server can freely set a fee to display to the client in the content profile, and an order at displaying a list to the client according to the contents of the fee is decided in the content scheduler.

Therefore, a user can easily acquire required content by a keyword search or the like and an order in a list in which contents displayed in the client are displayed is decided based on a fee for display, whereby the list in which contents are in a fair order based on the display fee can be displayed.

According to claim 11 of the present invention, in the information distribution system as defined in claim 10, the distribution server includes an accounting means which can execute an accounting processing to a content server or a content provider.

Therefore, the distribution server can execute an accounting processing, in addition to the same effect as that of the information distribution system according to claim 10 achieved.

According to claim 12 of the present invention, in an information distribution system comprising: a multi-purpose communication network which can transfer data by a wired-system cable or by wireless; a client which is connected to the communication network and has its primary object to display contents in a storage means inside; a content server which is connected to the communication network and provides information to the client; and a distribution server which is connected to the communication network, is provided with a content scheduler which receives a content profile describing contents of content from the content server and executes scheduling of content to be distributed to the client with reference to the contents of the content profile, and transfers a script file which can control the content execution in the client to the client, a keyword of corresponding content can be described in the content profile, the distribution server holds a search engine which enables a search of the content profile by a keyword sent from the client, and content selection can be performed by communicating the keyword and its search result between the client and the distribution server, and a description indicating that an advertisement is displayed during a content search operation by the client and a description of a fee for displaying the advertisement are included in the content profile, an advertisement related to the keyword employed for the content search by the client is selected in the content scheduler, and an adjustment is made to display an advertisement which is high in the advertisement display fee preferentially, when there are plural advertisements.

Therefore, a user can easily acquire required content by a keyword search or the like and the client which has its primary object to display is employed to display an advertisement while the client performs a content search operation, thereby providing a highly effective advertisement, and further, a schedule of advertisement display is adjusted based on a fee for the advertisement display in a server when a competition of plural advertisers displaying advertisements at the same time or the like occurs, whereby a fair scheduling can be automatically performed based on the display fee.

According to claim 13 of the present invention, in the information distribution system as defined in claim 12, the distribution server includes an accounting means which can execute an accounting processing to a content server or a content provider.

Therefore, the distribution server can execute an accounting processing, in addition to the same effect as that of the information distribution system according to claim 10 achieved.

According to claim 14 of the present invention, in the information distribution system comprising: a multi-purpose communication network which can transfer data by a wired-system cable or by wireless; a client which is connected to the communication network and has its primary object to display contents in a storage means inside; a content server which is connected to the communication network and provides information to the client; and a distribution server which is connected to the communication network, is provided with a content scheduler which receives a content profile describing contents of content from the content server and executes scheduling of content to be distributed to the client with reference to the contents of the content profile, and transfers a script file which can control the content execution in the client to the client, a keyword of corresponding content can be described in the content profile, the distribution server holds a search engine which enables a search of the content profile by a keyword specified by the client, and content selection can be performed by communicating the keyword and its search result between the client and the distribution server, and the distribution server is provided with an authenticating means for authenticating a user and a user information storage means for storing individual information of a user, and the content scheduler is provided with a keyword mask means which masks a keyword to be sent to the client based on the individual information stored in the user information storage means so as to suppress its sending to the client, thereby suppressing display of a keyword unnecessary for the user.

Therefore, a user can easily acquire required content by a keyword search or the like and a keyword unnecessary for the user can be prevented from being displayed in the client.

According to claim 15 of the present invention, in the information distribution system as defined in claim 14, the keyword to be masked can be set from the client.

Therefore, a non-display keyword can be set by a user himself/herself, in addition to the same effect as that of the information distribution system according to claim 14 achieved.

According to claim 16 of the present invention, in the information distribution system as defined in claim 14, the user information storage means is also provided with a function of managing the individual information of a user as well as keyword information selected by the user as statistical data, a keyword related to a description for identifying an advertisement distribution according to the keyword is described in the content profile, and the distribution server distributes an advertisement with reference to the statistical data of the user in the user information storage means.

Therefore, an advertisement related to a keyword selected often by a user can be displayed in the client, thereby providing a highly effective advertisement, in addition to the same effect as that of the information distribution system according to claim 14 achieved.

According to claim 17 of the present invention, in the information distribution system as defined in claim 16, the distribution server includes an accounting means which can execute an accounting processing to a content server or a content provider.

Therefore, the distribution server can execute an accounting processing, in addition to the same effect as that of the information distribution system according to claim 16 achieved.

According to claim 18 of the present invention, in the information distribution system as defined in claim 16, an inputting means which enables a user to input an information filed desired by himself/herself subjectively is provided, the user information storage means is also provided with a function of managing the information field as statistical data, and the distribution server distributes an advertisement with reference to the statistical data of the user in the user information storage means.

Therefore, an advertisement related to an information field desired by a user can be displayed in the client, thereby providing a highly effective advertisement, in addition to the same effect as that of the information distribution system according to claim 16 achieved.

According to claim 19 of the present invention, in the information distribution system as defined in claim 18, the distribution server includes an accounting means which can execute an accounting processing to a content server or a content provider.

Therefore, the distribution server can execute an accounting processing, in addition to the same effect as that of the information distribution system according to claim 18 achieved.

According to claim 20 of the present invention, in an information distribution system comprising: a multi-purpose communication network which can transfer data by a wired-system cable or by wireless; a client which is connected to the communication network and has its primary object to display contents in a storage means inside; a content server which is connected to the communication network and provides information to the client; and a distribution server which is connected to the communication network, is provided with a content scheduler which receives a content profile describing contents of content from the content server and executes scheduling of content to be distributed to the client with reference to the contents of the content profile, and transfers a script file which can control the content execution in the client to the client, a keyword of corresponding content can be described in the content profile, the distribution server holds a search engine which enables a search of the content profile by a keyword specified by the client, and content selection can be performed by communicating the keyword and its search result between the client and the distribution server, and information required to create an application executable in the client is previously disclosed, purchase price, rental price, and keyword information of content are described in the content profile issued by the content server which holds the content including the application, a user can select trial, purchase, or rental of the content, and the execution in the client automatically becomes impossible when trial or rental is selected and its validity period passes.

Therefore, an application desired by a user can be easily received by a keyword search or the like and the application can be executed in a usage manner (trial, rental, purchase) desired by the user.

According to claim 21 of the present invention, in the information distribution system as defined in claim 20, the distribution server includes an accounting means which can execute an accounting processing to a content server or a content provider.

Therefore, the distribution server can execute an accounting processing, in addition to the same effect as that of the information distribution system according to claim 20 achieved.

According to claim 22 of the present invention, in the information distribution system as defined in claim 20, the user information storage means holds individual information of a user as well as information of content purchased by the user, and a fee is not charged when the content is found to be already purchased with reference to the contents of the user information storage means, when the content is transmitted to the client.

Therefore, the distribution server can execute an appropriate accounting processing to the client, in addition to the same effect as that of the information distribution system according to claim 20 achieved.

According to claim 23 of the present invention, in the information distribution system as defined in claim 20, the distribution server holds a file which includes an application for setting executional environment of a terminal equipment of the client and a typical pattern of the executional environment of the terminal equipment, and the file including the application and the pattern is transmitted from the distribution server to the terminal equipment, so that the executional environment of the terminal equipment can be set by a simple menu operation, when a user sets the executional environment.

Therefore, a user can realize a complicated environmental setting of a terminal equipment only by the operation of selecting a typical pattern, thereby setting operational environment that suits the user by a simple method, in addition to the same effect as that of the information distribution system according to claim 20 achieved.

According to claim 24 of the present invention, in the information distribution system as defined in claim 23, the user information storage means hold individual information of a user as well as information for identifying the executional environment set by the user, and the executional environment of the client can be returned to its original state.

Therefore, a user can set operational environment that suits him/her by a simple method as well as easily return the operational environment to its original state.

According to claim 25 of the present invention, in the information distribution system as defined in claim 24, an application for setting the executional environment of the terminal equipment of a client and a background picture for the executional environment of the terminal equipment can be obtained from the content server, and the background picture can be selected from the content server when the user sets the executional environment.

Therefore, a background picture prepared by an advertiser can be displayed as a background picture of a client terminal, and a user can display a background picture that suits his/her taste from the user perspective, while an advertisement can be shown as a background of a client terminal to perform effective advertisement display from an advertiser perspective.

According to claim 26 of the present invention, in the information distribution system as defined in claim 25, the distribution server includes an accounting means which can execute an accounting processing to a content server or a content provider.

Therefore, when a user displays the background picture, a corresponding content server is charged a fee, in addition to the same effect as that of the information distribution system according to claim 25 achieved.

### BRIEF DESCRIPTION OF DRAWINGS

FIG. 1 is a block diagram of an entire information distribution system according to a first embodiment of the present invention.

FIG. 2(a) is a schematic diagram of contents of a client content storage means held by a client according to the first embodiment of the invention.

FIG. 2(b) is a schematic diagram of contents of a script file storage means held by a client according to the first embodiment of the invention.

FIG. 3 is a flow chart illustrating a flow of the operation of a content server and distribution server.

FIG. 4 is a diagram exemplifying a time schedule for displaying an advertisement on 1999/12/31.

FIG. 5 is a diagram exemplifying an invitation guideline disclosed from an information distribution server.

FIGS. 6(a) and (b) are diagrams exemplifying content profiles sent from the content server.

FIGS. 7(a) and (b) are diagrams exemplifying content profiles in a case where a competition in time frame occurs.

FIGS. 8(a) and (b) are diagrams exemplifying distribution schedules decided by a primary adjustment.

FIGS. 9(a) and (b) are diagrams exemplifying script files sent from the distribution server to a client.

FIG. 10 is a diagram exemplifying a content profile in a case where a distribution is urgently required.

FIGS. 11(a) and (b) are diagrams exemplifying script files sent to a client in case of urgent distribution.

FIG. 12 is a block diagram of a content scheduler in a case where a keyword is searched.

FIG. 13 is a diagram exemplifying a content profile in a case where a keyword is searched.

FIG. 14 is a diagram exemplifying a screen displaying a menu displayed in the first place.

FIGS. 15(a) and (b) are diagrams exemplifying menu display screens in a case where commodities are categorized.

FIGS. 16(a-1), (a-2), (b-1), (b-2), and (c) are diagrams exemplifying menu display screens in a case where commodities are selected by a keyword.

FIG. 17 is a diagram exemplifying an invitation guideline for a content-accompanying advertisement.

FIGS. 18(a) and (b) are diagrams exemplifying content profiles of the content-accompanying advertisement.

FIG. 19 is a diagram exemplifying a content profile when search results are prioritized.

FIG. 20 is a diagram exemplifying a screen display when the search results are prioritized.

FIG. 21 is a diagram exemplifying an invitation guideline for an advertisement which refers to keyword information.

FIG. 22 is a diagram exemplifying a screen display of an advertisement which refers to the keyword information.

FIG. 23 is a diagram exemplifying a content profile of an advertisement which refers to the keyword information.

FIG. 24 is a block diagram of a distribution server in a case where a keyword mask is performed on the basis of user information.

FIG. 25 is a block diagram of a content scheduler in a case where the keyword mask is performed on the basis of the user information.

FIGS. 26(a) and (b) are diagrams exemplifying screen displays in a case where the keyword mask is performed on the basis of the user information.

FIG. 27 is a diagram exemplifying an invitation guideline for an advertisement by a preference data base of a user on the basis of a keyword.

FIG. 28 is a diagram exemplifying a content profile of an advertisement by the preference data base of a user on the basis of a keyword.

FIGS. 29(a), (b), (c), and (d) are diagrams exemplifying menu screen displays when an advertisement required by a user is distributed.

FIGS. 30(a), (b), (c), (d), and (e) are diagrams exemplifying menu screen displays when an application is selected.

FIGS. 31(a) and (b) are diagrams exemplifying script files when the application is selected.

FIG. 32 is a diagram exemplifying a content profile in a case where the application is selected.

FIGS. 33(a), (b), (c), and (d) are diagrams exemplifying menu screen displays in case where operational environment of a terminal is set.

FIG. 34 is a diagram exemplifying an invitation guideline in a case where the operational environment of a terminal is set.

FIG. 35 is a diagram exemplifying a content file in a case where the operational environment of a terminal is set.

FIG. 36 is a block diagram of a conventional entire system.

### BEST MODE TO EXECUTE THE INVENTION

### Embodiment 1

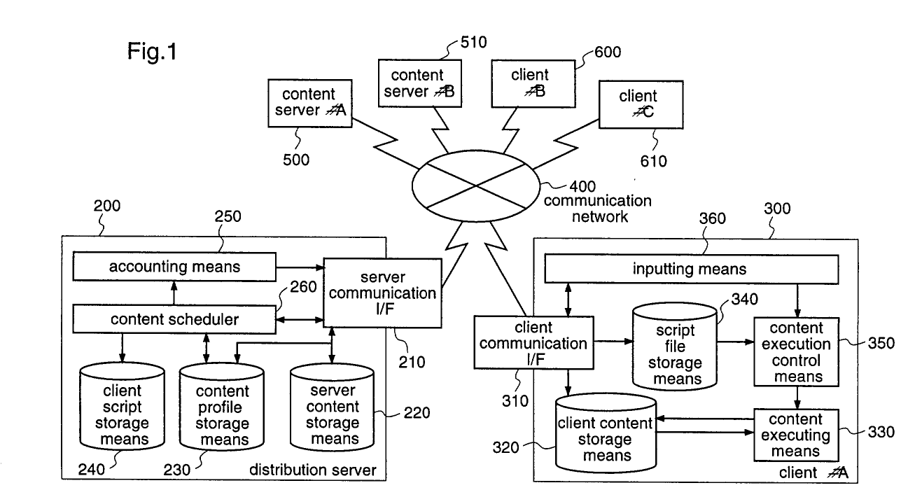

An embodiment of the present invention defined in claims 1, 2, and 3 of the invention will be described with reference to FIG. 1.

FIG. 1 is a block diagram of an entire information distribution system, and a case wherein two content servers and three clients are connected to a distribution server through a communication network is exemplified in this embodiment.

In FIG. 1, numeral 200 denotes a distribution server, numeral 300 denotes a client #A, numeral 400 denotes a communication network of a wired/wireless system, numeral 500 denotes a content server #A, numeral 600 denotes a content server #B, numeral 610 denotes a content server #C, numeral 210 denotes a server communication interface which is an interface to the communication network 400, numeral 220 denotes a server content storage means for storing content, numeral 230 denotes a content profile storage means for storing a profile of each content sent from the content server #A or the content server #B, numeral 240 denotes a client script storage means for storing a client script for each client, numeral 250 denotes an accounting means for managing the cost generated in the system, numeral 260 denotes a content scheduler which creates the client script for each client with reference to contents of the content profile sent from each content server, numeral 310 denotes a client communication interface which is an interface to the communication network 400, numeral 320 denotes a client content storage means for storing content sent through the communication network 400, numeral 330 denotes a content executing means for executing the contents of the client content storage means 320, numeral 340 denotes a script file storage means for holding a script file sent through the communication network 340, numeral 350 denotes a content execution control means which interprets the contents of the script file storage means 340 to support a control to the content executing means 330, and numeral 360 denotes an inputting means by which a user inputs.

The information distribution system according to the embodiment comprises the distribution server, the content servers, and the clients. Respective roles will be described briefly. The content server creates and manages substance of content and a content profile (in which information related to the content is described). The distribution server manages and operates the content profile and provides content information required by the client. The client communicates with the distribution server to acquire the content information, and acquires the substance of content from the content server to execute the content.

The client assumed in the present invention is connected to the communication network 400 and is a terminal (such as an electronograph stand, a message board, or a telephone with liquid crystal) which has its primary object to display content regularly. Respective elements by the above-described constitution will be described in detail.

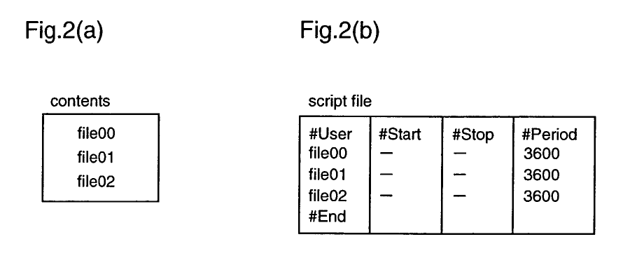

First, a function and operation of the client will be described. FIG. 2 illustrates contents of the client content storage means 320 and contents of the script file included in the script file storage means 340, and these contents are previously set in the client #A by a prescribed procedure (the contents are transferred from each content server by a menu operation to be stored in the client content storage means 320).

Contents of the script file described below are given as an example and they do not always have to follow this format.

FIG. 2(a) illustrates the contents of the client content storage means, in which File00/File01/File02 are kept as an example. FIG. 2(b) illustrates the contents of the script file kept in the script file storage means 340. What are described here are previously set by a user who utilizes the client, and file name (#User)/start time (#Start)/finish time (#Stop)/execution time (#Period (second)) can be set as a filed of the script file.

In this case, there is indicated a procedure that files are executed for 3600 seconds (an hour) in the order of File00/File01/File02 and this operation is repeated.

The operation of the client #A will be described. The content execution control means 350 interprets the contents of the script file storage means 340 (FIG. 2(b)) and prompts the content executing means 330 to perform a specific execution. The content executing means 330 reads a required file from the contents of the client content storage means 320 (FIG. 2(a)) to execute the content. That is, the client #A has the client communication I/F 310 take charge of an interface to the external communication network 400, and executes the contents of the client content storage means 320 according to the contents of the script file kept in the script file storage means 340.

Next, the operation of the distribution server 200, the content server #A 500, and the content server #B 510 will be described. In the embodiment, an advertisement which is often employed as content is given as a specific example, and the client is capable of displaying the contents of the advertisement. Therefore, one who manages the content server is an advertiser and the advertiser provides various types of information to the distribution server 200.

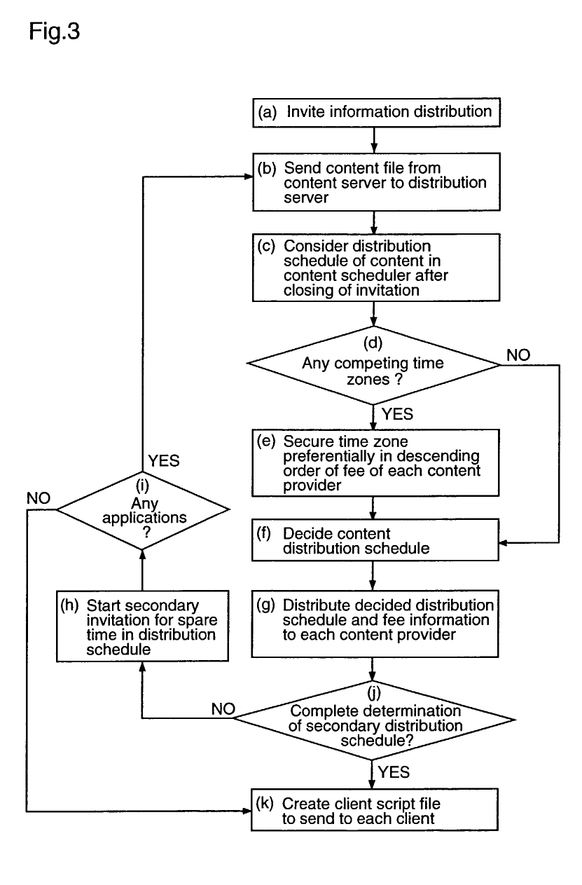

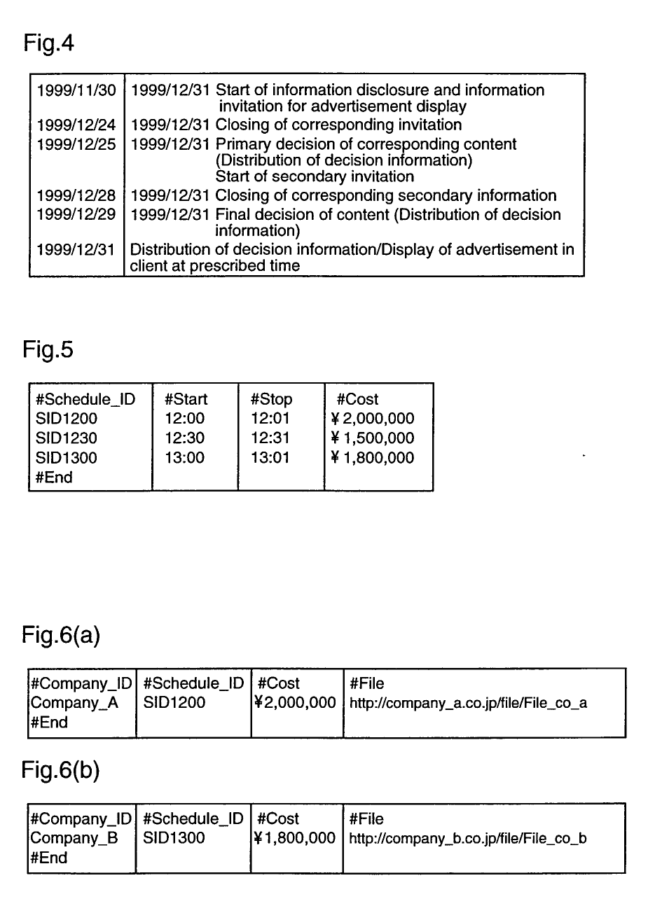

FIG. 3 is a flow chart explaining the operation of the whole content servers and the distribution server, and FIG. 4 illustrates a time schedule for displaying an advertisement on Dec. 31, 1999. Hereinafter, a description will be given according to (a)-(k) in FIG. 3, and the time schedule therein complies with that in FIG. 4.

(a) An invitation for an information distribution is started (Nov. 30, 1999). Information on a time frame in which an advertisement received from the content server by the client can be displayed and its fee is previously disclosed to an advertiser from the distribution server 200. The information on a time frame and its fee is exemplified in FIG. 5. In FIG. 5, time frame ID (Schedule_ID)/start time (Start)/finish time (Stop)/fee (Cost) are disclosed as the information.

(b) The content profile is sent from the content server to the distribution server (Nov. 30, 1999-Dec. 24, 1999).

The content profile is exemplified in FIG. 6. FIG. 6(a) illustrates a content profile from the content server #A and FIG. 6(b) illustrates a content profile from the content server #B. Contents included in the content profile are company identification ID (Company_ID)/required schedule (Schedule_ID)/cost (Cost)/file link information (File).

(c) A distribution schedule of the content is considered in the content scheduler 260 after the closing of an invitation (1999/12/25).

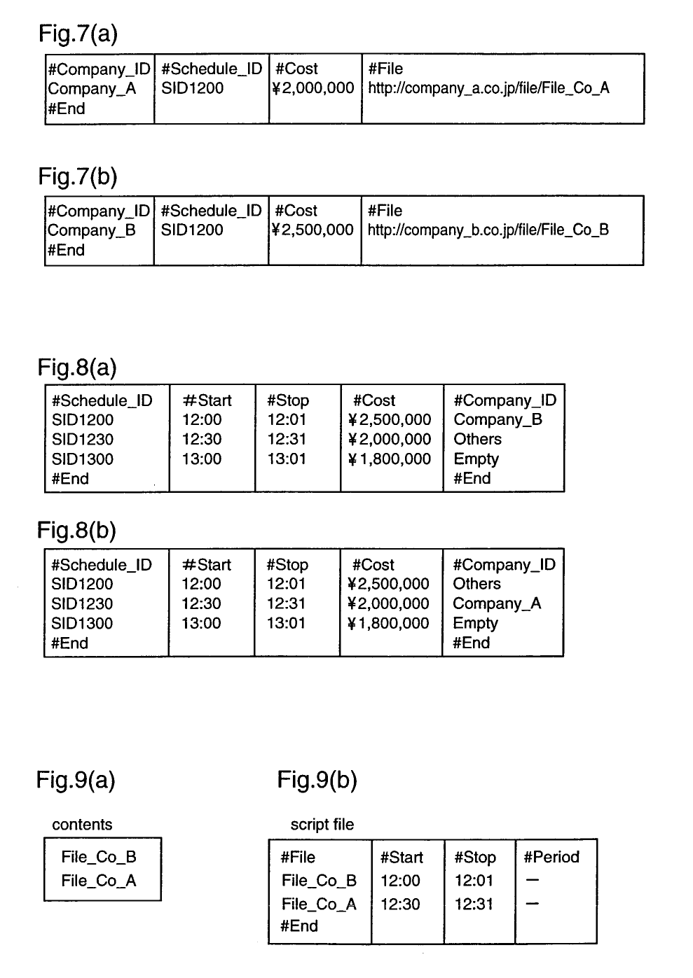

(d) Whether there is a competing time zone or not is investigated (Dec. 25, 1999). Whether there is a competing time zone or not is checked in the content scheduler 260 from the information of the content profile obtained from each content provider. In case of FIG. 6 wherein there is no competing time zone, the processing subsequently shifts to the operation of (f). A case where there is a competition will be exemplified in FIG. 7 for reference. In case of FIG. 7, the time zone of 12:00 coincides. In this case, the following operation of (e) is performed.

(e) The time zone is preferentially secured in descending order of fee of each content provider (Dec. 25, 1999).

In case of FIG. 7, when the fee block is compared, the content provider #A is ¥2,000,000 while the content provider #B is ¥2,500,000, and thus, 12:00 is allocated to the content provider #B.

(f) The content distribution schedule is decided (Dec. 25, 1999). When there is no competition (FIG. 6), allocation of a time zone required by each content is performed unconditionally and the distribution schedule is decided.

When a competition occurs (FIG. 7), allocation is preferentially decided in (e), and the time zone of 12:30 is allocated to the content provider #A which cannot be allocated as required. In this case, a method of including a second-choice time zone in the content profile is also conceivable. In this description, a time zone right after the required time is allocated.

The schedule is decided as it is when no competition occurs, and thus, the following description will be given of a case where a competition occurs in detail.

(g) The decided distribution schedule and fee information are distributed to each content provider (Dec. 25, 1999).

The decided distribution schedule is exemplified in FIG. 8. FIG. 8(a) illustrates a distribution schedule distributed to the content provider #B and FIG. 8(b) illustrates a distribution schedule distributed to the content provider #A.

(h) A secondary invitation for spare time in the distribution schedule is started (Dec. 25, 1999). Since a time adjustment may be required again when allocation to the required time cannot be performed, a secondary invitation is performed again. It is also possible to accept cancellation or to recognize modification to spare time at secondary invitation.

(i) The secondary invitation is closed (Dec. 28, 1999). When there is no application on the closing day, the processing shifts to the operation of (k). When there is modification or the like, the operation of (b)-(g) is performed to decide a final distribution schedule.

(j) Whether a determination of the secondary distribution schedule is completed or not is checked (Dec. 29, 1999). When the determination of the final secondary distribution schedule is completed, the processing shifts to the operation of (k).

(k) The client script file is created and is sent to each client (Dec. 30, 1999).

The script file (FIG. 9) for each client is created in the content scheduler 260 and is transferred to each client. At this time, each advertiser is charged a fee (See FIG. 8) accompanying the content distribution to the client, totalization is performed by the period decided in an arrangement with the advertiser, and the content provider is finally charged a required fee in the accounting means 250. The distribution server 200 serves as a proxy server, thereby enabling an effective distribution.

While substance of the file provided by an advertiser is held by each advertiser (content server), it is previously cashed to the server content storage means 220 of the distribution server 200 so that the distribution to the client is executed effectively. That is, File_Co_A in the content serever #A and File_Co_B in the content server #B are held in the server content storage means 220. Thereby, the distribution server can transfer the script file as well as transfer the substance of the file to the client content storage means 320. It is also possible that the client directly communicates with the content server to have the file transferred when there is no problem in distribution efficiency.

Next, the operation of the client after an advertisement is distributed to the client by the above-described operation will be described briefly. A user script file (FIG. 2(b)) previously defined by a user and an advertisement script file (FIG. 9(b)) sent from the distribution server exist in the script file storage means 340 of the client #A 300. Further, user content (FIG. 2(a)) previously held by a user and advertisement content (FIG. 9(a)) sent from the distribution server exist in the client content storage means 320.

The client basically performs an operation according to the user script file, while executes the operation according to the advertisement script file when it is time defined in the advertisement script file. The example as described above will be specifically described as follows.

file00 is executed for 3600 seconds (an hour).

file01 is executed for 3600 seconds (an hour).

file02 is executed for 3600 seconds (an hour).

This is repeatedly executed.

File_Co_B is executed for a minute when it is 12:00.

File_Co_A is executed for a minute when it is 12:30.

The Client Executes the Above-described Operation.

When a user interactively operates the client at a time specified in the advertisement script file, the advertisement script file is executed after the user finishes the operation. In this way, the client side can provide an advertisement at a time subjectively required by an advertiser while the client automatically executes the file specified by a user. The client can execute a self-set file and an advertiser can provide an effective advertisement to the client, whereby this system is highly practically effective. The distribution server 200 manages only the content profile, so that a hardware of the distribution server can be constructed in a small size.

The file described in the embodiment is a highly versatile file which can be executed by the client and includes an image data file (JPEG, BMP, GIF, and the like), voice data, a text file, an application, and the like, in the concrete, and thus it is not to be restricted to a specified one. While the content of the content server is described as an advertisement in the embodiment, information other than the advertisement (such as news and a new service introduction) can be actually applied.

### Embodiment 2

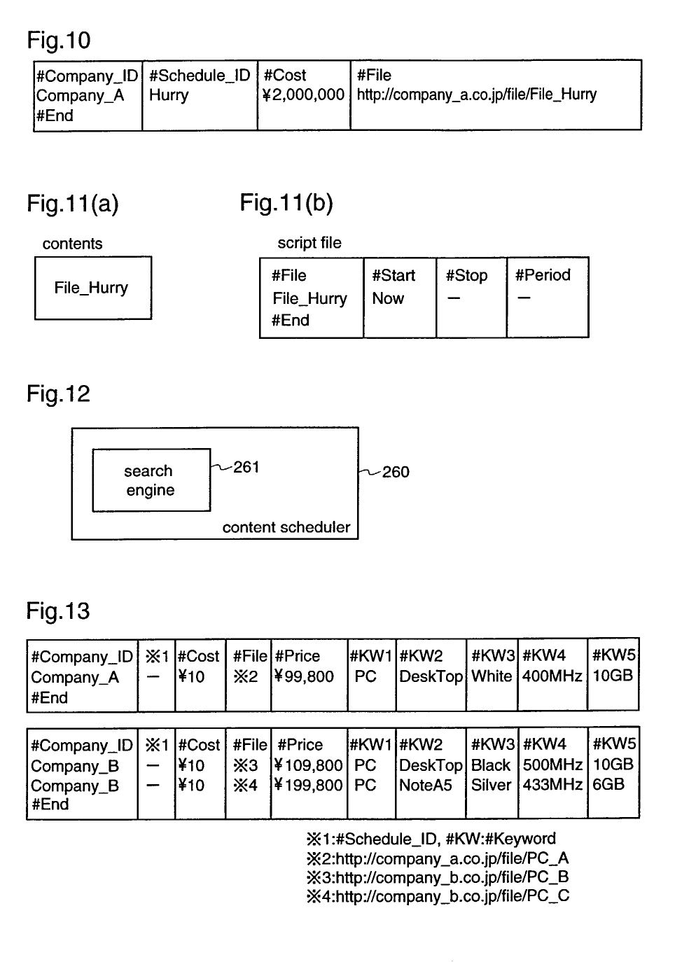

An embodiment of the present invention defined in claims 4 and 5 of the invention will be described with reference to FIG. 10. The same constructions as those shown in the above-described embodiment are denoted by the same reference numerals, and their descriptions will be omitted.

This second embodiment employs the information distribution system described in the first embodiment and distributes urgent information to all the clients simultaneously so as to enable the execution thereof at the client side. To realize this working, the content profile sent from the content server is thought out. FIG. 10 exemplifies a content profile in a case where content which requires to be distributed urgently is sent from the content server #A. In this case, “Hurry” is described in the field of the required schedule (Schedule_ID), so that it is recognized as an urgent distribution information.

The operation of an urgent distribution will be described with reference to FIG. 1.

(1) A content profile as shown in FIG. 10 is sent from the content server #A 500 to the distribution server 200

(2) The content profile is stored in the content profile storage means 230 as well as transferred to the content scheduler 260 through the server communication I/F 210.

(3) The content profile is interpreted and is recognized as urgent information, and a script file as shown in FIG. 11 is generated in the content scheduler 260. “Now” is specified in the start time (Start) field in the script file so as to prompt an immediate execution.

(4) The script file as well as a target file File_Hurry are transferred to each client.

(5) The client interprets the script file and immediately executes the File_Hurry. At this time, a running file is suspended. The execution of the File_Hurry is repeatedly performed unless a user specifies. The user stops the file execution by the inputting means 360.

In this way, urgent information is distributed to all the clients and is immediately executed at the client side.

The client side can immediately execute information only by describing information indicating urgency in the content file, whereby it is extremely available as a means for conveying urgent information. While there is a network by a telephone as an existing simultaneous communication means, delay time occurs in this method. Further, in case of a means by local broadcasting and premises broadcasting, it can be only known in the place. While an e-mail or the like is employed as a simultaneous broadcasting means on the Internet, it has a problem in terms of urgency. As compared with these existing means, information can be communicated to the whole with much higher rate, resulting in a profound effect. With respect to a fee in the urgent distribution, an accounting processing is performed to the content server which provides information in the accounting means 250, when the script file is distributed to each client.

### Embodiment 3

An embodiment of the present invention defined in claims 6 and 7 of the invention will be described with reference to FIGS. 1 and 12. The same constructions as those shown in the above-described embodiment are denoted by the same reference numerals, and their descriptions will be omitted.

FIG. 12 illustrates the content scheduler 250 in FIG. 1, in which a search engine 251 is included here.

The third embodiment enables an information search by a keyword by the above-described constitution, and a description will be given of electronic shopping as its typical example. A content server holds substance of a content (commodity) file which describes each commodity in detail, and the distribution server 200 manages a content profile which includes a keyword concerning the commodity (which is sent from the content server). The distribution server 200 can correspond to a keyword search of a user based on the content profile. When the content server utilizes this system, a utility rate is required.

In the embodiment, a user selects a keyword by a simple operation, thereby doing his/her so-called electronic shopping. Hereinafter, its contents will be described employing a concrete example. FIG. 13 exemplifies a content profile in a case where a content provider provides content that includes a description of a commodity as an object of electronic shopping. Here, commodities concerning PC are provided from Company_A (A company) and Company_B (B company). The following contents are added to those described in the first embodiment.

Commodity price (#Price field)

Commodity keyword (#keyword field)

While five keywords are set in the embodiment, the number of keywords are not restricted.

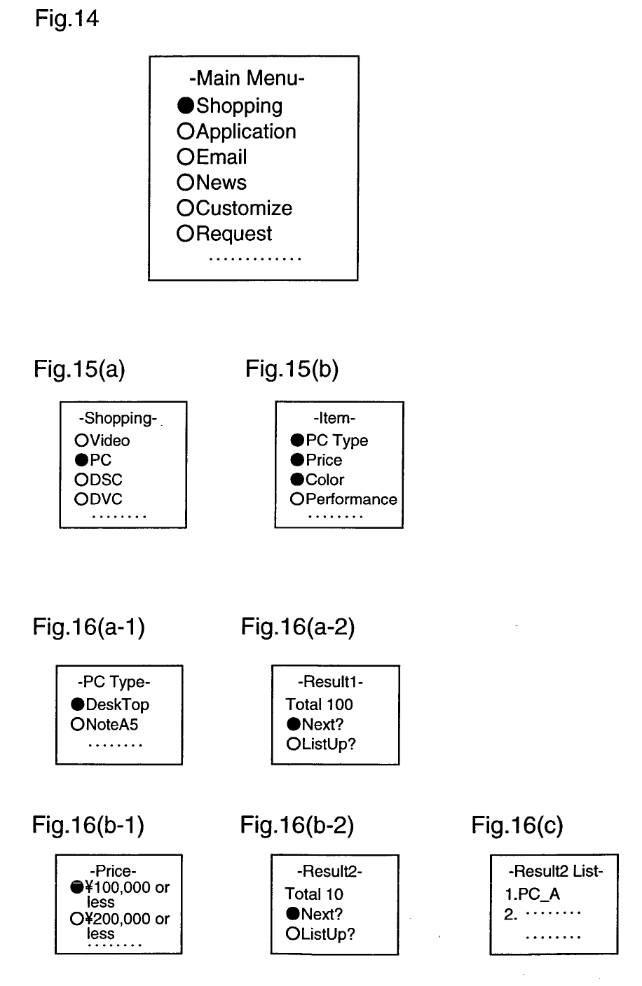

A fee in a case where content is displayed to the client is indicated in the filed of cost in the content profile. The fee is decided by a manager of the distribution server and each content server is previously informed of it. A method for a user to do his/her electronic shopping employing this system will be described with reference to FIGS. 14, 15, and 16.

(1) A menu screen of electronic shopping appears (See FIG. 15(a)) by that electronic shopping (Shopping) is selected from an initial menu (See FIG. 14) by the inputting means 360 in the client #A 300.

More specifically, an application for performing electronic shopping is previously loaded in the client content storage means 320 of the client #A, and the application is executed in the content executing means 330, so that the menu screen of electronic shopping is displayed.

(2) A commodity to be purchased is selected from the menu screen. Here, PC is selected (item of ● in FIG. 15(a)). This information acquired by the inputting means 360 is immediately transferred to the content scheduler 260 in the distribution server 200, and items concerning PC are listed up in the search engine 261.

(3) When the commodity is selected, the operation shifts to a next menu screen and a screen as shown in FIG. 15(b) is displayed. That is, detailed items concerning the commodity are displayed.

A script file which displays the items listed up in the search engine 261 is created by the content scheduler 260 and is transferred to the client #A. The client #A receives the script file and displays contents according to its instruction, and a user selects items to pay notice to at commodity purchase. Here, Type/Price/Color are selected (items of ● in FIG. 15(b)).

The same operation as that described above is subsequently performed between the distribution server 200 and the client #A, thereby to display.

(4) Keywords are displayed for each item selected by (3). In FIG. 16(a-1), keywords concerning Type are displayed and Desk Top is selected.

(5) According to the first keyword, the search engine 251 described in FIG. 12 searches content including the keyword of “Desk Top” from the content profile storage means 230 and displays the result on the client side (See FIG. 16(a-2)).

(6) A user selects whether to display a list of the search result (ListUp) here from the first search result or to continue searching by a next keyword (Next). Here, a next search is executed.

(7) According to a second keyword, content is searched in the same way as that in (5) to display on the client side (See FIG. 16(b-1)). Keywords concerning the price are displayed and 100,000 yen or less is selected here. According to the second keyword, the search engine 251 described in FIG. 12 searches content including the keyword of “100,000 yen or less” from the content profile storage means 230 and displays the result on the client side (See FIG. 16(b-2)).

(8) The same operation as that of (6) is performed. A list of the search result is displayed (ListUp) here (See FIG. 16(c)).

In this way, a keyword search is performed for a previously selected item, whereby a user can narrow down a commodity in consideration and list up the whole commodity candidates when there are finally as few commodity candidates as the user can select.

Commodity candidates finally narrowed down are displayed as shown in FIG. 16(c), and a corresponding company is charged a fee described in the Cost filed of the content profile as shown in FIG. 14 in the accounting means 250 when the distribution server 200 transmits the commodity candidates to the client #A.

A user selects one whose detailed information he/she wants to know from the display screen by the inputting means 360, so that substance of a file is transferred from the content server to the client #A, and the user can see contents of the file. Electronic shopping can be done in this way. Since a user can narrow commodity candidates down only by selecting a keyword, the user can decide a commodity to buy by minimum commodity comparison. Also, when providing a content, keywords and price information of a commodity are only described into the content profile, thereby enabling an accounting processing and also an information provision to user.

While the description is given taking an electronic shopping as an example here, various contents (such as news, a hobby, transportation, stocks, a photograph, music, and e-mail) can be displayed or executed in the same way. The distribution server respectively sets costs for those contents.

### Embodiment 4

An embodiment of the present invention defined in claims 8 and 9 of the invention will be described with reference to FIGS. 1, 17 and 18. The same constructions as those shown in the above-described embodiment are denoted by the same reference numerals, and their descriptions will be omitted.

The fourth embodiment displays related information (such as an advertisement) when content is completed to be narrowed down by a keyword and finally selected content is displayed as described in the third embodiment. A description will be given of a case where an advertisement is displayed as the related information here.

An advertisement accompanying content is invited in the same way as that described in the first embodiment. Contents of the invitation guideline at this time are the same as those described in FIG. 5, though the contents in Schedule_ID field are different.

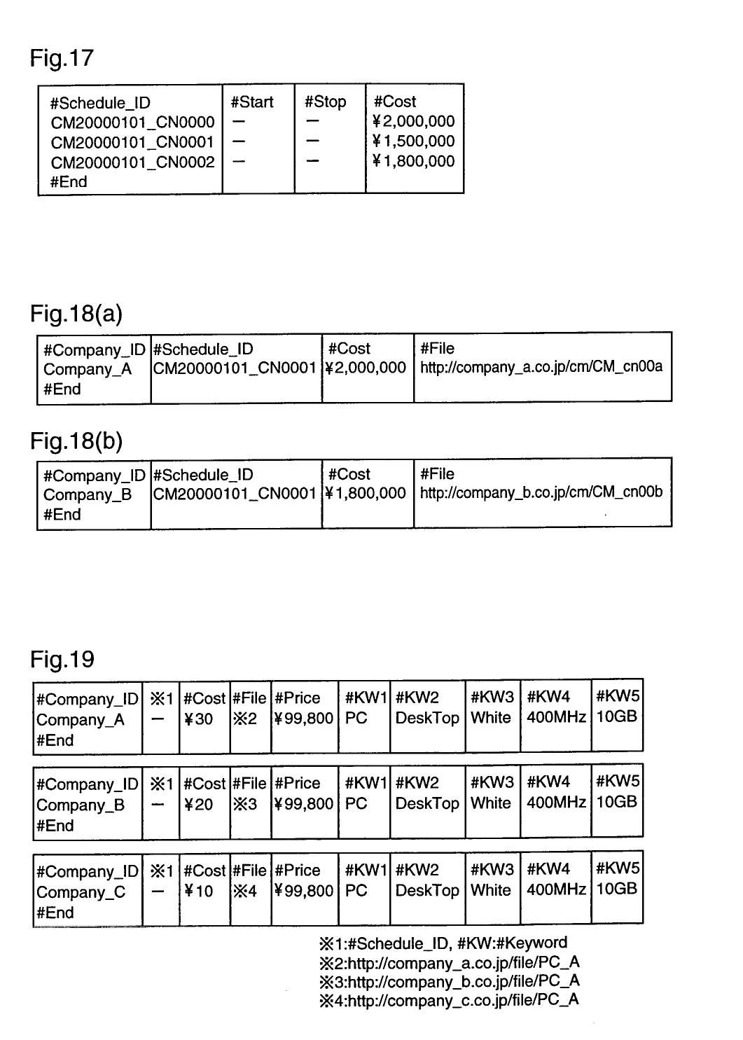

FIG. 17 is an example. In FIG. 17, meanings of the description in the Schedule_ID field are as follows, and a date on which an advertisement is displayed and a target content ID are indicated.

CM20000101_CN0000: CN000 content on Jan. 1, 2000

CM20000101_CN0001: CN001 content on Jan. 1, 2000

CM20000101_CN0002: CN002 content on Jan. 1, 2000

In response to the above-described advertisement invitation, content profiles (See FIG. 18) are sent from respective advertisers (content servers). When there is one application for the same date and content, that application advertisement is decided, while when a competition is generated, an adjustment is made in the content scheduler 260. In case of FIG. 18, for example, because there is a competition exactly between the same contents, the content with a higher cost recited in the Cost field is selected in the same way as described in the first embodiment.

Accordingly, the CM of Company_A is decided as an advertisement accompanying the content CN0001 of Jan. 1, 2000. When a user performs a search to select the content CN0001 in the same way as described in the third embodiment, the CN0001 as well as an advertisement CM_cn00a are transferred from the distribution server 200 to the client #A. At the client #A, the content CN0001 is displayed, and then the advertisement CM_cn00a is displayed.

Whether an distribution server is displayed before the display of the target content or after the display of the target content can be previously decided at the side of the distribution server. In this way, it is possible to display an advertisement with attaching to the content. By employing this method, it is possible to perform an affective advertisement by attaching an advertisement to a popular content.

Further, when an advertisement relating to the content is offered, it becomes an advertisement that is useful for a user as well as highly effective for an advertiser, resulting in a profound effect.

While an advertisement is described as information attached to content in the embodiment, information other than an advertisement (such as news and music) can also be attached to the same. Further, while an advertisement display fee is described as the same one as in the first embodiment, the fee system can be freely decided by the distribution server.

### Embodiment 5

An embodiment of the present invention defined in claims 10 and 11 of the invention will be described with reference to FIGS. 1, 19 and 20. The same constructions as those shown in the above-described embodiment are denoted by the same reference numerals, and their descriptions will be omitted.

The fifth embodiment concludes narrowing content down by a keyword as described in the third embodiment and exercises ingenuity in the order of display of the finally selected result. As methods of displaying the result, there are one which displays at random or one which displays by a sorting with attention to a keyword. The one to be described hereinafter enables a content server which provides its content to perform a priority control for the display order.

As described in the third embodiment, the content profile has the Cost filed inside, in which a fee required at a display to the client is described. While a minimum fee is announced on the distribution server side, this amount of money can be freely described on the content server side. The characteristic of the embodiment is that when a list of narrowed down content is displayed, an order of their display is decided in preference of one with a higher fee described in the Cost field.

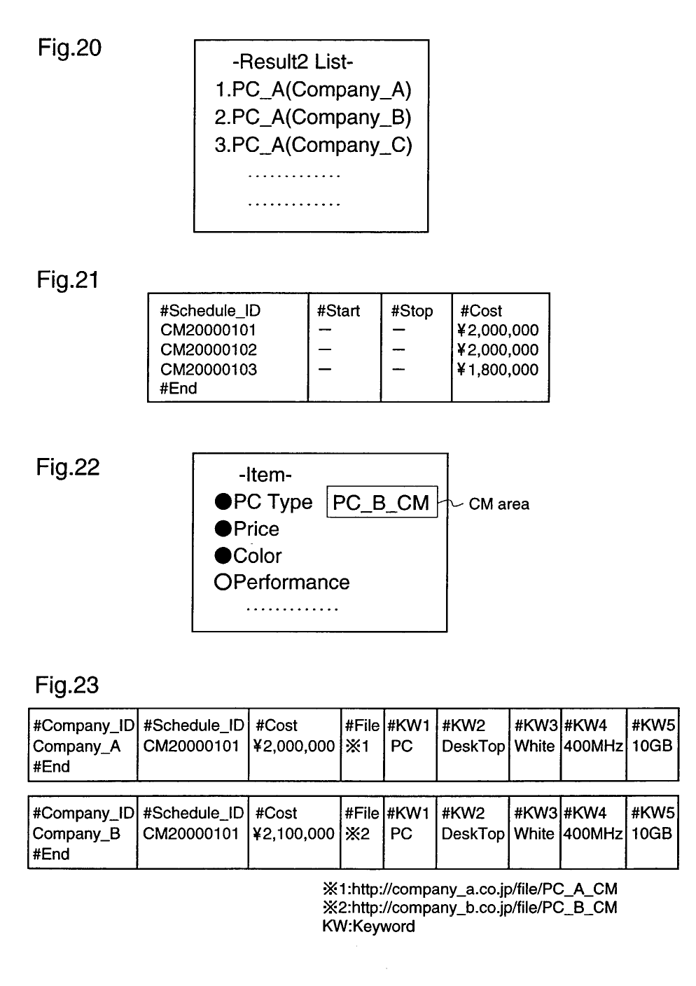

A description will be given with a concrete example. It is supposed that three kinds of candidates as shown in FIG. 19 are finally selected by the operation in the third embodiment. In this case, they are exactly the same in keyword and price. A difference is only in the Cost field. When the script file which displays the search result is transmitted to the client #A, the Cost field in each content profile is compared and a script file which preferentially displays one with a higher value is created in the content scheduler 260, and the script file is transmitted to the client #A. At this time, an accounting processing is simultaneously performed in the accounting means 250. The client #A which received the script file displays the list as shown in FIG. 20.

Conventionally, a display itself is performed in an order (such as an alphabetical order) which is uniquely decided by a system, and the order is decided only by contents of words to be displayed. In case of content which cannot be seen without paging, for example, a chance that they are seen is bound to be decreased, resulting in disadvantage from a content provider perspective.

The present system can preferentially display by setting a display fee higher than a minimum fee as well as by contents of words, thereby reducing the above-described unfairness. Particularly, in case of electrical shopping in which commodities are purchased, an obvious difference occurs between when they are at the head of the list and when they cannot be seen without paging. Therefore, this system enables a content provider side to have the initiative in preferential order in display, resulting in a profound effect.

### Embodiment 6

An embodiment of the present invention defined in claims 12 and 13 of the invention will be described with reference to FIGS. 21, 22 and 23. The same constructions as those shown in the above-described embodiment are denoted by the same reference numerals, and their descriptions will be omitted.

The sixth embodiment is a new means for displaying an advertisement in selection of content narrowed down by a keyword as described in the third embodiment. An advertisement related to a keyword selected desirously by a user is displayed in a selection menu in the third embodiment, and FIG. 22 illustrates an example. In FIG. 22, a screen, in which a user selects “PC” and a list of keywords related to “PC” is displayed, displays an advertisement related to “PC” inside. An advertisement which interests a user can be displayed by this advertisement display, resulting in an extremely high advertising effectiveness.

This method of displaying an advertisement will be described. The whole working for displaying an advertisement is almost the same as that in the first embodiment. Hereinafter, only the parts different from those in the first embodiment will be described.

(a) An advertisement is invited from the distribution server 200 toward an advertiser (content server), and its invitation guideline may be one as shown in FIG. 21. In FIG. 21, meanings of the contents in the Schedule_ID field are as follows.

CM20000101: displayed in CM area in content search menu (Jan. 1, 2000)

CM20000102: displayed similarly (Jan. 2, 2000)

CM20000103: displayed similarly (Jan. 3, 2000)

(b) A keyword field is required in the content profile. This is because a keyword is required to execute the contents described in the third embodiment.

Excepting those above, it is the same as in the first embodiment.

(1) A user performs a search of “PC” on Jan. 1, 2000.

(2) The distribution server 200 detects a content profile that corresponds in a search by keywords “PC” and “CM20000101” in the search engine 261. As a result, content files as shown in FIG. 23 are supposed to be obtained. The content scheduler 260 compares the contents in the Cost filed to select the content of Company_B, which is high in fee, in this case.

(3) A screen (menu and CM area) as shown in FIG. 22 is displayed in the client #A.

In this way, a CM can be displayed in the menu screen. When there is a case where the menu screen is continued, a corresponding CM is displayed according to a rule previously decided by the distribution server 200. For example, it is a case where corresponding content is displayed in descending order of display fee or a case where a CM with high display fee only is always displayed. The distribution server 200 can freely decide the above-described rule.

As described above, according to the embodiment, an advertisement related to a user's interest is displayed during the menu operation, whereby the user side obtains useful information while an advertiser side can display a remarkably effective advertisement. Therefore, the value of an advertisement is remarkably increased.

While a description is given of an advertisement display in the embodiment, various other contents (such as news, related information, music, and animation) can be executed.

### Embodiment 7

An embodiment of the present invention defined in claims 14 and 15 of the invention will be described with reference to FIGS. 1, 24, 25 and 26. The same constructions as those shown in the above-described embodiment are denoted by the same reference numerals, and their descriptions will be omitted.

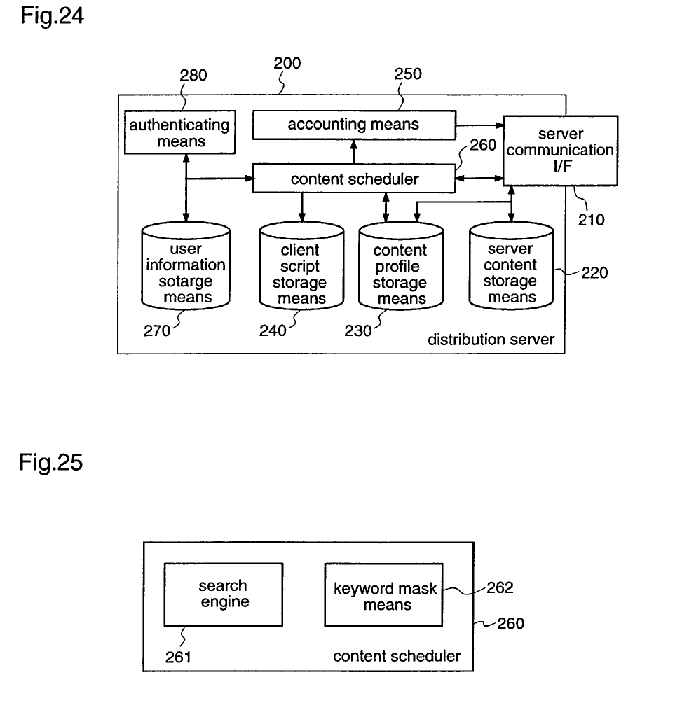

FIG. 24 is a diagram illustrating a construction of a distribution server 200 of an information distribution system according to the seventh embodiment. In the figure, numeral 280 denotes an authenticating means for performing a user authentication, and numeral 270 denotes a user information storage means which holds user's personal information. FIG. 25 is a detail view of the content scheduler 260 in FIG. 24, and numeral 262 denotes a keyword mask means which masks an unnecessary item so as to prevent a user from seeing.

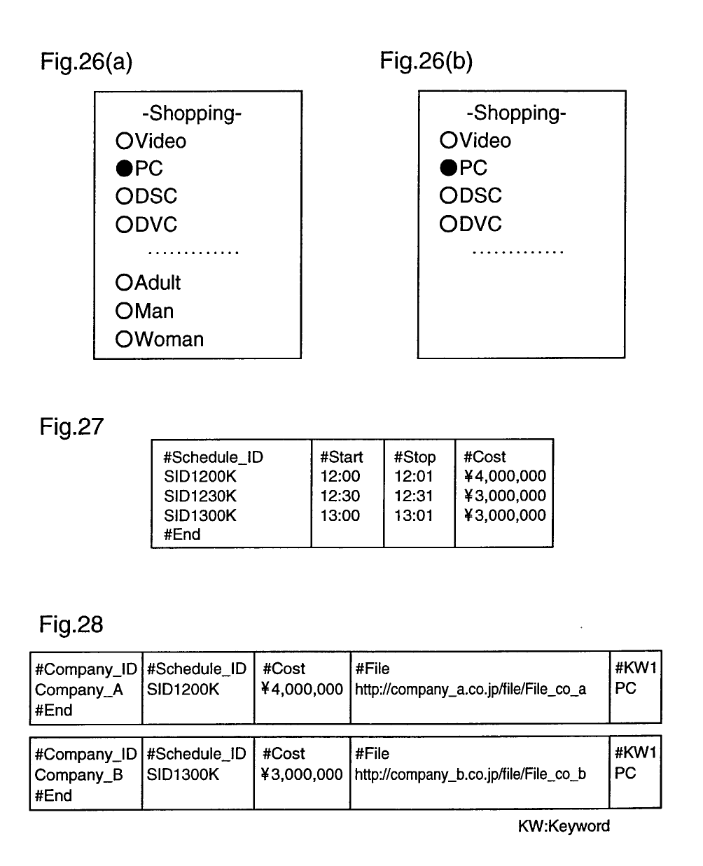

When shopping is done by the operation described in the third embodiment, a menu screen of commodity items is first displayed. There can be various types of commodity items at the time, which include one that can be seen only by particular people, one that targets at adults, one that only targets at men or women, or the like. Therefore, when these commodity items are disclosed with no filter, items as shown in FIG. 26(a) are displayed on the menu display of a client. This enables people underage, who are actually prohibited from seeing, to select an item of “Adult” in the menu. The embodiment provides a means for masking a display item to avoid this situation.

A list of items to be masked is previously created in the keyword mask means 262. An example is as follows.

Adult: masking for under-18 people

Man: masking for under-18 people and women

Woman: masking for under-18 people and men

When the system is used, an operation of user authentication is performed. For example, an ID and password of a user are inputted employing the inputting means 360 of the client #A, and the user is authenticated in the authenticating means 280. Personal information on a user is previously held in the user information storage means 270.

When a user selects a shopping menu, the content scheduler 260 reads a user ID confirmed in the authenticating means 280 and personal information (such as age and sex) of the user held in the user information storage means 270, and masking is performed to a commodity item list (See FIG. 26(a)) outputted from the search engine 261 based on the above-described rule in the keyword mask means 262. By this mask operation, when an under-18 boy is using a client terminal, for example, a menu screen as shown in FIG. 26(b) is displayed.

In this way, a menu item can be masked according to a previously decided rule, whereby a user can be relieved to employ this system. In another respect, it is also possible to display secret information only to a related user.

While only the menu item at shopping is described here, it is possible to mask a specified keyword in exactly the same way in case of a search by a keyword.

### Embodiment 8

An embodiment of the present invention defined in claims 16 and 17 of the invention will be described with reference to FIGS. 1, 24, 27 and 28. The same constructions as those shown in the above-described embodiment are denoted by the same reference numerals, and their descriptions will be omitted.

When an advertisement distribution method as described in the first embodiment is performed, an advertisement is distributed based on a user preference, thereby further increasing the effect of the advertisement distribution. A keyword of a commodity to be shopped can be cited as a method by which a user associates a field which interests him/her.

For example, a keyword in the keyword search as described in the third embodiment is recorded as personal information of a user and an advertisement related to the keyword is provided to a target user, whereby the value of the advertisement is supposed to be increased further. This embodiment is a system which realizes the above-described contents, and requires two phases in the realization, (a) a record of keyword information of each user and (b) an advertisement distribution based on the recorded keyword.

Hereinafter, the operation in each phase will be described in detail.

(a) Record of User's Individual Keyword Information

The menu screen as shown in FIG. 15(a) appears in the operation in the third embodiment and a user selects a keyword therein (“PC” in case of FIG. 15). When the user selects an item and its information is notified to the distribution server 200, the selected item “PC” is stored in the user information storage means 270 as each individual information. Statistical data of keywords for an individual user are held in the user information storage means 270.

(b) Advertisement Distribution Based on Recorded Keyword

A flow of the advertisement distribution is the same as that described in the first embodiment, and only differences will be described.

### Time Frame ID in Invitation for Information Distribution

FIG. 27 exemplifies an invitation guideline for an advertisement invitation which introduces a user preference based on FIG. 5. A code which enables distinction from FIG. 5 is assigned in the time frame ID.

### Contents of Content Profile

FIG. 28 exemplifies a content profile from an advertiser, which is the contents of the Schedule_ID based on the above-described disclosed information and includes a field of a related keyword.

### Advertisement Distribution

When it is reserved time, a user who has a keyword that coincides with a keyword in the content profile is selected with reference to the keyword statistical data of each individual user in the user information storage means 270, and an advertisement is distributed to the selected user. In case of FIG. 28, an advertisement is distributed to a user with the keyword “PC” recorded.

In this way, an advertisement is distributed based on the statistical data of keywords which have been referred to by a user, whereby the user side can see an advertisement which interests him/her while an advertiser side does not have to distribute a useless advertisement. The value of an advertisement is remarkably increased for both sides.

### Embodiment 9

An embodiment of the present invention defined in claims 18 and 19 of the invention will be described with reference to FIGS. 1, 24 and 29. The same constructions as those shown in the above-described embodiment are denoted by the same reference numerals, and their descriptions will be omitted.

The ninth embodiment allows a user to specify information (including an advertisement) desired by the user, thereby to increase the value of an advertisement. A method for realizing this is basically the one wherein a keyword described in the eighth embodiment is not recorded in the user information storage means 270 but is demonstratively inputted by a user by a menu operation. Thus, the menu operation of a user and a record to the user information storage means 270 will be described.

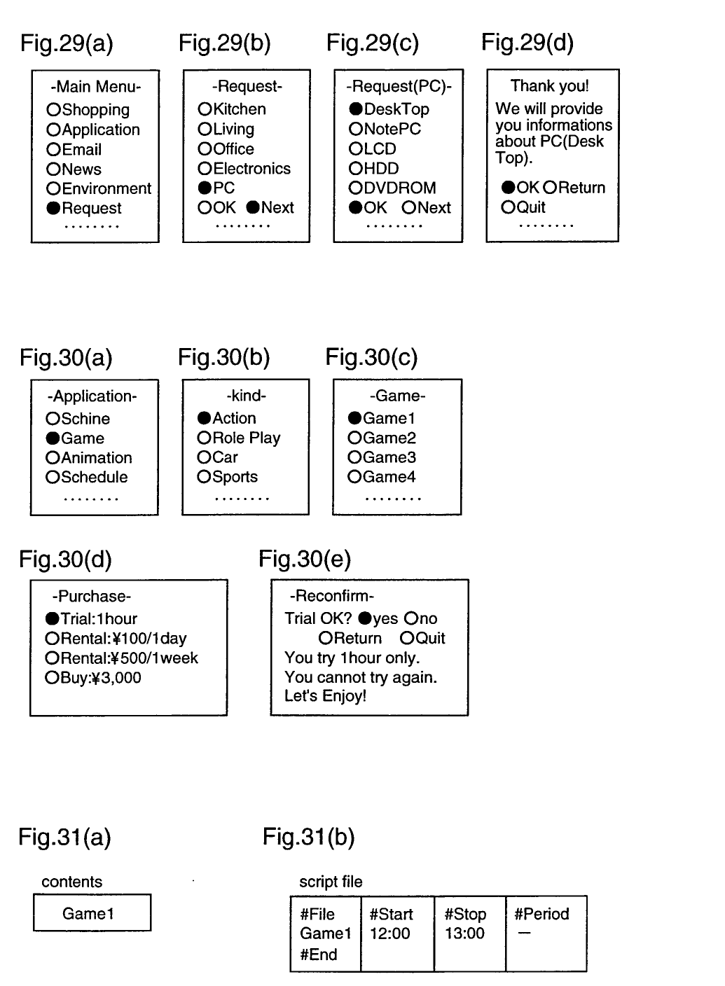

FIG. 29 illustrates a menu screen indicating the above-described state. A description will be given in the order of (a)-(d) of FIG. 29.

(a) “Request” is Selected From a Main Menu Screen.

(b) Main Items are Displayed.

“PC” is selected here. In case of information on the whole PC, “OK” is selected. When specification is to be performed in more detail, “Next” is selected.

(c) Classified Items Concerning PCs are Displayed.

“DeskTop” is selected here. When “OK” is selected, information on DeskTop in the PCs can be obtained.

(d) A Confirmation Screen is Displayed.

Finally, selected information is held in the user information storage means 270.

The above-described operation is performed by the same operation as in the eighth embodiment executed inside the distribution server 200 and the client #A. With respect to the content profile, the one employed in the eighth embodiment can be applied as it is.

As described above, the operation after the selected information is held in the user information storage means 270 is the same as in the eighth embodiment.

Further, the method described in the embodiment is applicable to the advertisement distributions described in the first, sixth, and eighth embodiments.

As described above, according to the embodiment, a user can acquire information (advertisement) required by himself/herself and an advertiser can distribute a remarkably valuable advertisement, resulting in a profound effect.

While a description is given of an advertisement in the embodiment, it is possible to apply to various other contents (such as news and music).

### Embodiment 10

An embodiment of the present invention defined in claims 20 and 21 of the invention will be described with reference to FIGS. 1, 30, 31 and 32. The same constructions as those shown in the above-described embodiment are denoted by the same reference numerals, and their descriptions will be omitted.

Information (such as API/development environment/specification) required to create an application executable in the client #A is opened to public. A maker which developed an application becomes the content server in FIG. 1 and this system is used so that a client can use its content. A content profile as shown in FIG. 30 is sent from the content server to the distribution server 200. FIG. 30 exemplifies the content profile for an application.

It includes the following fields therein (Those described by the ninth embodiment are omitted).

#Price: selling price

#Rental1: rental price for one-day application use

#Rental2: rental price for one-week application use

#Keyword: keyword for selection

“Application” is selected on the menu screen (See FIG. 14) so that a user uses the application. The operation of selecting a menu is the same as that in the third embodiment. FIG. 30 exemplifies a state of a display screen after the application is selected. The screen proceeds from FIGS. 30(a) to (c) by selecting keywords.

Here, “Game1” is supposed to be finally selected. Then, the screen as shown in FIG. 30(d) is displayed. There are the following four cases as usage modes of Game1.

Trial: trial of Game1 for only an hour

Rental1: rental for a day (¥100)

Rental2: rental for a week (¥500)

Buy: purchase of Game1 (¥3000)

A user selects one of the above four.

Next, the screen in FIG. 30(e) is displayed. This is a display screen for reconfirming the selection of a user, in which a content of the menu is selected.

yes: selected here when the selection is right

no: selected here when the selection is wrong

return: selected here when the screen returns to the previous menu screen

quit: selected here when the application selection screen is quit

In case of “yes”, the operation is performed according to its contents.

Hereinafter, the operation after the selection is completed in a setting of FIG. 30(e) will be described.

(1) Script File Creation

A script file as shown in FIG. 31(b) is created in the content scheduler 260. FIG. 31(b) exemplifies the script file in case of “Trial” and expresses that a finish time (#Stop) is 13:00 when it is 12:00 at present. The finish time is accordingly set in case of “Rental1” and “Rental2”. It is not particularly set in case of “Buy”.

(2) Transfer of Script File to Client

The distribution server 200 transfers the script file to the client #A. At this time, an accounting processing is executed to a user according to the usage manner (Trial/Rental1/Rental2/Buy) selected by the user in the accounting means 250. Simultaneously, a fee for application utility is paid to a target content server and a processing fee (previously decided) is paid to the distribution server 200 in the accounting means 250.

The client #A which received the script file receives substance of the file from a corresponding content server and holds it in the client content storage means 320 (See FIG. 31a).

(3) Execution of Script File by Client

The client #A performs execution according to the received client file. The content stored in the client content storage means 320 is supposed to be held only for a period set in the script profile. That is, target content cannot be executed when the period passes.

In this way, a user can receive a desired application, the application can be executed in a usage manner (trail, rental, purchase) desired by the user, and the distribution server can charges a fee according to the usage manner, whereby a system easy to use for both of the user and the distribution server can be realized.

Further, information is disclosed to create an application operated in the client and a user can use the created application in the above-described way, whereby a wide variety of applications are developed and a user can use many applications in an accessible usage manner to himself/herself, resulting in a profound effect.

### Embodiment 11

An embodiment of the present invention defined in claim 22 of the invention will be described with reference to FIGS. 1 and 24. The same constructions as those shown in the above-described embodiment are denoted by the same reference numerals, and their descriptions will be omitted.

In the description in the tenth embodiment, the content purchased by a user is stored in the client content storage means 320. However, the client content storage means 320 has a capacity limit and can not always store many contents. That is, there is circumstantially a need to update the contents of the client content storage means 320. According to circumstances, some of the contents may be erased. Here will be described a method for acquiring content from the distribution server 200 and a content server many times without once purchase content being charged a fee.

A description on purchased content is given in the user information storage means 27 as user individual information when a client script file is sent from the distribution server 200 to a client, while content can be obtained in the way as described in the tenth embodiment. When the client script is sent from the distribution server 200, it is confirmed whether a user purchases target content or not with reference to the contents of the user information storage means 270, and a fee is charged in the accounting means 250 in case of no description of purchase while a fee is not charged in case of a description of previous purchase.

In this way, a user can acquire purchased content from a server any number of times, and the distribution server 200 stores records of purchase in the user information storage means 270, so as to put to use when creating user's statistical data.

### Embodiment 12

An embodiment of the present invention defined in claims 23 and 24 of the invention will be described with reference to FIGS. 1 and 33. The same constructions as those shown in the above-described embodiment are denoted by the same reference numerals, and their descriptions will be omitted.

The characteristic of an information distribution system according to the twelfth embodiment is that when a user sets executional environment (such as a screen background or an inputting means) of a terminal, typical patterns are previously prepared and the user selects therefrom, thereby enabling the user to set favorable environment easily.

Conventionally, when a user sets environment of a terminal equipment, there is a need to understand each function of the terminal equipment and set individual environment, resulting in an extremely difficult setting. This embodiment provides a method of making this easy.

A typical pattern of executional environment of a client and an environmental setting application for the client to mount the pattern are held in the server content storage means 220 of the distribution server 200. A background of a menu screen or an inputting means, for example, are required to be set as the executional environment.

Hereinafter, a method of client terminal setting by a user will be sequentially described.

(1) Environmental setting (Customize: See FIG. 14) is selected from a menu screen. At this time, the environmental setting application is sent from the distribution server 200 to the client #A, and the client #A receives the application to execute.

(2) An item of environmental setting is selected. Screen (background setting) is selected in FIG. 33(a). At this time, a typical pattern for background setting is sent from the distribution server 200 to the client #A.

(3) The typical patterns are sequentially displayed and a user finds a pattern that suits him/her therefrom to select. Typical patterns as shown in FIGS. 33(b), (c), and (d) are displayed, and “Yes” is selected when there is something that suits one in the screen at that time. When there is nothing that suits one, “No, Next” is selected and a next screen is displayed.

(4) The environment selected by a user is set in the client. The environmental setting application to be operated in the client #A sets the state of the client device so that a display screen selected by a user with “yes” is a standard background.

The environment of the client device is set by the above-described operation, and the execution can be performed in the newly set environment when a user uses the device next. While the description is given taking setting of a screen background for example here, an inputting manner of the terminal equipment or other environmental setting can be set by a typical pattern selected.

As described above, according to the embodiment, complicated environmental setting of the terminal equipment can be realized only by the operation of selecting a typical pattern, whereby a user can set operational environment that suits him/her by a simple method, resulting in a profound effect that usability of the terminal equipment is enhanced.

### Embodiment 13

An embodiment of the present invention defined in claims 25 and 26 of the invention will be described with reference to FIGS. 1, 34 and 35. The same constructions as those shown in the above-described embodiment are denoted by the same reference numerals, and their descriptions will be omitted.

While a screen background can be set by the method described in the twelfth embodiment, a pattern of the screen background can be always seen when a user performs the menu operation, and thus it is thought to be valuable as an advertisement. Then, a background pattern is widely invited publicly and a user selects it, so that the background pattern itself can give an advertisement value.

Hereinafter, a method for realizing the above-described contents will be described. The whole stream is the same as that in the twelfth embodiment. A difference is that a screen of a background selected by a user is content (background picture) which is invited publicly.

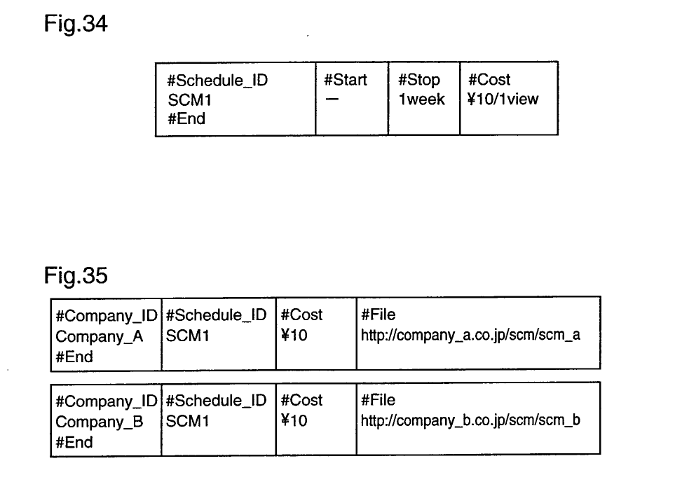

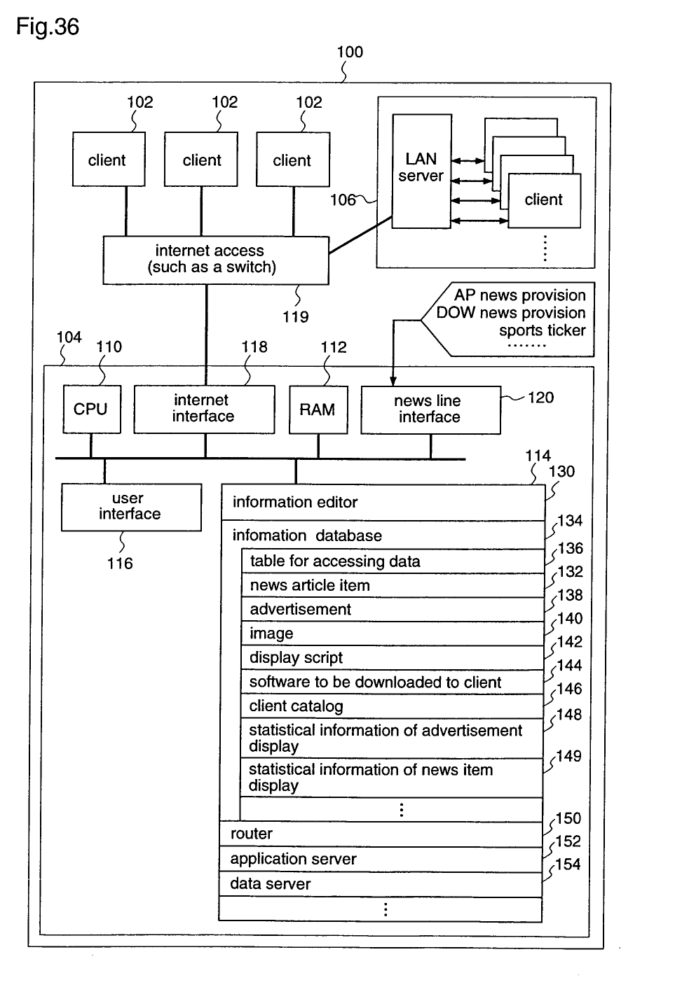

First, a condition at menu setting of a client is disclosed from the distribution server 200. FIG. 34, which is its example, illustrates that when a user selects target content as a background screen of a menu, the same content is used as a background picture of the menu screen for a week since then and ¥10 is paid to an advertiser every time the user opens the screen.

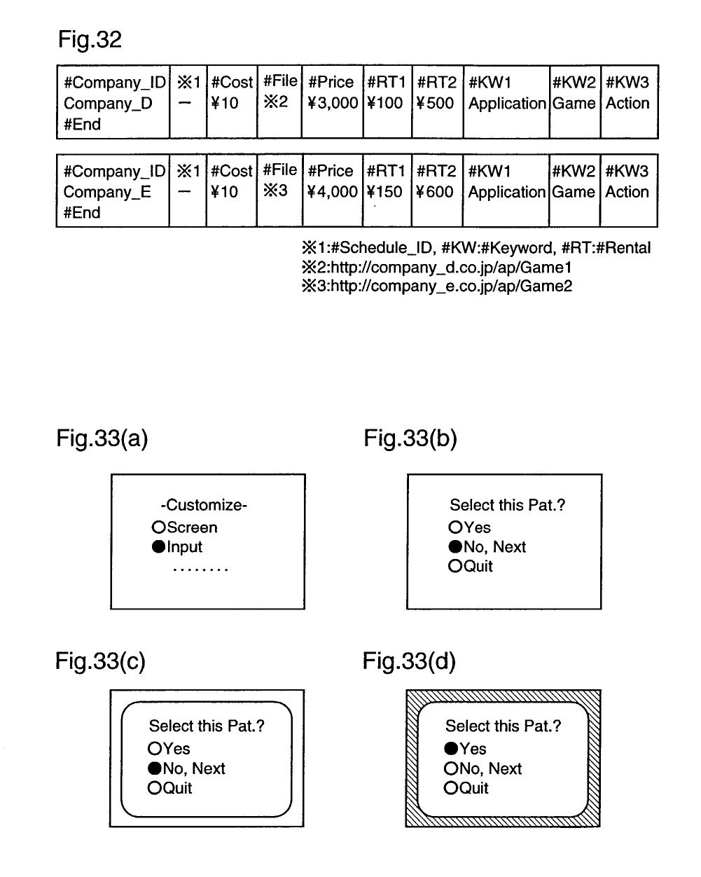

For the above-described condition, a content profile is transmitted from a content server as an advertiser to the distribution server 200. The content profile at the time is exemplified in FIG. 32. SCM1 which indicates a background paint at menu display is described in the Schedule_ID field in the FIG. 32. The file specified in the content profile corresponds to the background paint held by the distribution server described in the twelfth embodiment.

Hereinafter, a description will be given with reference to FIG. 33.

(1) Environmental setting (Customize) is selected from the menu screen. The operation at this time is the same as that in the twelfth embodiment.

(2) An item of environmental setting is selected. In FIG. 33(a), Screen (background setting) is selected. At this time, a background picture transmitted by a public invitation is sent to the client #A. When there is two kinds of background pictures as shown in FIG. 35, this file is transmitted. Further, a background picture previously prepared by the distribution server 200 is also transmitted to the client #A.

(3) The typical patterns are sequentially displayed and a user finds a pattern that suits him/her therefrom to select. Typical patterns as shown in FIGS. 33(b), (c), and (d) are displayed, and “Yes” is selected when there is something that suits one in the screen at that time. When there is nothing that suits one, “No, Next” is selected and a next screen is displayed.

(4) The environment selected by a user is set in the client. The environmental setting application to be operated in the client #A sets the state of the client device so that a display screen selected by a user with “yes” is a standard background. At this time, information of the content profile selected by the user is described in the client information storage means 270 in the distribution server 200.

The environment of the client device is set by the above-described operation, and the execution can be performed in the newly set environment when a user uses the device next. While the description is given taking setting of a screen background for example here, an inputting manner of the terminal equipment or other environmental setting can be set by a typical pattern selected. At this time, when a file by Company_A as shown in FIG. 35 is selected, the file of SCM_A of Company_A is displayed as a background every time a user opens the menu screen, and, when there is information of menu operating from the user at this time, a fee is paid to an advertiser in the accounting means 250 with reference to the contents of the user information storage means 270.

As described above, a background picture prepared by an advertiser can be displayed as a background picture in a menu screen of a client terminal. A background picture that suits one can be displayed from a user perspective, while an advertisement can be shown as a background of a client terminal from an advertiser perspective, whereby it is remarkably effective in terms of the value of an advertisement to a user.

While a display period of a background picture is prescribed as a week in the description in the embodiment, it is not necessarily required to restrict the period. When there is generated a case where the contents of the background picture of Company_A described here are changed, its contents are notified to a user, so that the user can switch the background freely.

While a background picture to be selected is limited to one in the embodiment, it is also possible to set plural background pictures.

### APPLICABILITY IN INDUSTRY

As described above, an information distribution system according to the present invention can provide a remarkably effective advertisement employing a client which has its primary object to display, and corresponds particularly to high efficiency of a net advertisement in net business industry, which is dramatically expanding in recent years.

1. An information distribution system comprising: a multi-purpose communication network which can transfer data by a wired-system cable or by wireless; a client which is connected to the communication network and has its primary object to display contents in a storage means inside; a content server which is connected to the communication network and provides information to the client; and a distribution server which is connected to the communication network, receives a content profile in which contents of content and a utility fee required with content execution are described from the content server, and transfers a script file which can control the content execution in the client to the client, wherein a client execution time at which corresponding content is executed in the client can be specified in the content profile, and the distribution server adjusts the client execution time based on the utility fee when the client execution time has competition.

2. The information distribution system as defined in claim 1, wherein the distribution server includes an accounting means which can execute an accounting processing to a content server or content provider.

3. The information distribution system as defined in claim 1, wherein the client comprises: a client communication I/F as an interface to the communication network; a script file storage means for storing the script file from the client communication I/F; a client content storage means for storing content data from the client communication I/F; a content executing means for executing the contents of the client content storage means; and a content execution control means for controlling the content executing means with reference to the contents of the script file storage means, and the distribution server comprises: a server communication I/F as an interface to the communication network; a content profile storage means for holding the content profile from the server communication I/F; and a content scheduler which executes scheduling of content to be distributed to the client with reference to the contents of the content profile storage means.

4. The information distribution system as defined in claim 1, wherein a description indicating urgency can be given in the content profile, the distribution server confirms the description indicating urgency given in the content profile to transfer a script file indicating urgency to a target client immediately, and the client which received the script file immediately receives and executes target content.

5. The information distribution system as defined in claim 4, wherein the distribution server includes an accounting means which can execute an accounting processing to a content server or a content provider.

6. The information distribution system as defined in claim 1, wherein a keyword and price information of corresponding content can be described in the content profile, the distribution server holds a search engine which enables a search of the content profile by a keyword sent from the client, and content can be selected by communicating the keyword and its search result between the client and the distribution server.

7. The information distribution system as defined in claim 6, wherein the distribution server includes an accounting means which can execute an accounting processing to a content server or a content provider, and the accounting processing is performed when the client executes a candidates of the content.

8. An information distribution system comprising: a multi-purpose communication network which can transfer data by a wired-system cable or by wireless; a client which is connected to the communication network and has its primary object to display contents in a storage means inside; a content server which is connected to the communication network and provides information to the client; and a distribution server which is connected to the communication network, is provided with a content scheduler which receives a content profile describing contents of content from the content server and executes scheduling of content to be distributed to the client with reference to the contents of the content profile, and transfers a script file which can control the content execution in the client to the client, wherein
a keyword of corresponding content can be described in the content profile, the distribution server holds a search engine which enables a search of the content profile by a keyword sent from the client, and content selection can be performed by communicating the keyword and its search result between the client and the distribution server, and
information for identifying target content to be accompanied and a fee to be displayed to the client are described in the content profile, information that accompanies the target content to be accompanied is decided according to the contents of the fee in the content profile in the content scheduler, and the client executes the accompanying information before or after the target content to be accompanied is executed.

9. The information distribution system as defined in claim 8, wherein the distribution server includes an accounting means which can execute an accounting processing to a content server or a content provider.

10. An information distribution system comprising: a multi-purpose communication network which can transfer data by a wired-system cable or by wireless; a client which is connected to the communication network and has its primary object to display contents in a storage means inside; a content server which is connected to the communication network and provides information to the client; and a distribution server which is connected to the communication network, is provided with a content scheduler which receives a content profile describing contents of content from the content server and executes scheduling of content to be distributed to the client with reference to the contents of the content profile, and transfers a script file which can control the content execution in the client to the client, wherein
a keyword of corresponding content can be described in the content profile, the distribution server holds a search engine which enables a search of the content profile by a keyword sent from the client, and content selection can be performed by communicating the keyword and its search result between the client and the distribution server, and
the content server can freely set a fee to display to the client in the content profile, and an order at displaying a list to the client according to the contents of the fee is decided in the content scheduler.

11. The information distribution system as defined in 10, wherein the distribution server includes an accounting means which can execute an accounting processing to a content server or a content provider.

12. An information distribution system comprising: a multi-purpose communication network which can transfer data by a wired-system cable or by wireless; a client which is connected to the communication network and has its primary object to display contents in a storage means inside; a content server which is connected to the communication network and provides information to the client; and a distribution server which is connected to the communication network, is provided with a content scheduler which receives a content profile describing contents of content from the content server and executes scheduling of content to be distributed to the client with reference to the contents of the content profile, and transfers a script file which can control the content execution in the client to the client, wherein
a keyword of corresponding content can be described in the content profile, the distribution server holds a search engine which enables a search of the content profile by a keyword sent from the client, and content selection can be performed by communicating the keyword and its search result between the client and the distribution server, and
a description indicating that an advertisement is displayed during a content search operation by the client and a description of a fee for displaying the advertisement are included in the content profile, an advertisement related to the keyword employed for the content search by the client is selected in the content scheduler, and an adjustment is made to display an advertisement which is high in the advertisement display fee preferentially, when there are plural advertisements.

13. The information distribution system as defined in 12, wherein the distribution server includes an accounting means which can execute an accounting processing to a content server or a content provider.

14. An information distribution system comprising: a multi-purpose communication network which can transfer data by a wired-system cable or by wireless; a client which is connected to the communication network and has its primary object to display contents in a storage means inside; a content server which is connected to the communication network and provides information to the client; and a distribution server which is connected to the communication network, is provided with a content scheduler which receives a content profile describing contents of content from the content server and executes scheduling of content to be distributed to the client with reference to the contents of the content profile, and transfers a script file which can control the content execution in the client to the client, wherein
a keyword of corresponding content can be described in the content profile, the distribution server holds a search engine which enables a search of the content profile by a keyword specified by the client, and content selection can be performed by communicating the keyword and its search result between the client and the distribution server, and
the distribution server is provided with an authenticating means for authenticating a user and a user information storage means for storing individual information of a user, and the content scheduler is provided with a keyword mask means which masks a keyword to be sent to the client based on the individual information stored in the user information storage means so as to suppress its sending to the client, thereby suppressing display of a keyword unnecessary for the user.

15. The information distribution system as defined in claim 14, wherein the keyword to be masked can be set from the client.

16. The information distribution system as defined in claim 14, wherein the user information storage means is also provided with a function of managing the individual information of a user as well as keyword information selected by the user as statistical data, a keyword related to a description for identifying an advertisement distribution according to the keyword is described in the content profile, and the distribution server distributes an advertisement with reference to the statistical data of the user in the user information storage means.

17. The information distribution system as defined in 16, wherein the distribution server includes an accounting means which can execute an accounting processing to a content server or a content provider.

18. The information distribution system as defined in claim 16, wherein an inputting means which enables a user to input an information filed desired by himself/herself subjectively is provided, the user information storage means is also provided with a function of managing the information field as statistical data, and the distribution server distributes an advertisement with reference to the statistical data of the user in the user information storage means.

19. The information distribution system as defined in 18, wherein the distribution server includes an accounting means which can execute an accounting processing to a content server or a content provider.

20. An information distribution system comprising: a multi-purpose communication network which can transfer data by a wired-system cable or by wireless; a client which is connected to the communication network and has its primary object to display contents in a storage means inside; a content server which is connected to the communication network and provides information to the client; and a distribution server which is connected to the communication network, is provided with a content scheduler which receives a content profile describing contents of content from the content server and executes scheduling of content to be distributed to the client with reference to the contents of the content profile, and transfers a script file which can control the content execution in the client to the client, wherein
a keyword of corresponding content can be described in the content profile, the distribution server holds a search engine which enables a search of the content profile by a keyword specified by the client, and content selection can be performed by communicating the keyword and its search result between the client and the distribution server, and
information required to create an application executable in the client is previously disclosed, purchase price, rental price, and keyword information of content are described in the content profile issued by the content server which holds the content including the application, a user can select trial, purchase, or rental of the content, and the execution in the client automatically becomes impossible when trial or rental is selected and its validity period passes.

21. The information distribution system as defined in 20, wherein the distribution server includes an accounting means which can execute an accounting processing to a content server or a content provider and a client or a user.

22. The information distribution system as defined in claim 20, wherein the user information storage means holds individual information of a user as well as information of content purchased by the user, and a fee is not charged when the content is found to be already purchased with reference to the contents of the user information storage means, when the content is transmitted to the client.

23. The information distribution system as defined in claim 20, wherein the distribution server holds a file which includes an application for setting executional environment of a terminal equipment of the client and a typical pattern of the executional environment of the terminal equipment, and the file including the application and the pattern is transmitted from the distribution server to the terminal equipment, so that the executional environment of the terminal equipment can be set by a simple menu operation, when a user sets the executional environment.

24. The information distribution system as defined in claim 23, wherein the user information storage means hold individual information of a user as well as information for identifying the executional environment set by the user, and the executional environment of the client can be returned to its original state.

25. The information distribution system as defined in claim 24, wherein an application for setting the executional environment of the terminal equipment of a client and a background picture for the executional environment of the terminal equipment can be obtained from the content server, and the background picture can be selected from the content server when the user sets the executional environment.

26. The information distribution system as defined in claim 25, wherein the distribution server includes an accounting means which can execute an accounting processing to a content server or a content provider, and a corresponding content server can be charged a fee when a user displays the background picture.
